(19) United States
(12) Patent Application Publication
(10) Pub. No.: US 2005/0264040 A1
(43) Pub. Date: Dec. 1, 2005

(54) Structurally reinforced cross-car beam

(76) Inventors: Thomas Gregory Bailey, Highland, MI (US); Daniel V. Beckley, Fenton, MI (US); Lisa Ann Grems, West Bloomfield, MI (US); Steven D. McClintock, South Lyon, MI (US); Jeromy D. Weible, Waterford, MI (US)

Correspondence Address: HONIGMAN MILLER SCHWARTZ AND COHN LLP, 32270 TELEGRAPH RD, SUITE 225, BINGHAM FARMS, MI, 48025-2457, US

(21) Appl. No.: 10/857,198

(22) Filed: May 28, 2004

(51) Int. Cl. B62D 25/00

(52) U.S. Cl. 296/193.02

(57) ABSTRACT

A structurally reinforced cross-car beam is comprised of a plastic material impregnated with long reinforcement fibers. The long reinforcement fibers have a length of at least three-quarters of an inch. The plastic material may be a thermoplastic and the reinforcement fibers may be comprised of glass fibers. The cross-car beam may also include a first portion comprised of a metallic material, such as magnesium, and a second portion comprised of the plastic material impregnated with long reinforcement fibers.

### TECHNICAL FIELD

The present invention relates to cross-car beam comprised of a plastic material, and in particular to a cross-car beam comprised of a plastic material structurally reinforced with long reinforcement fibers.

### BACKGROUND OF THE INVENTION

It is known that vehicles traditionally include a cross-car beam extending transversely across the vehicle. The cross-car beam is generally disposed at the cowl of the vehicle or the junction between an engine compartment and a passenger compartment. The cross-car beam is a structural component of the vehicle connecting opposite A-pillars of the vehicle body. The cross-car beam provides stiffness, manages side impact loads, provides steering column support and absorbs the reaction force of the passenger supplemental inflatable restraint (PSIR) when it is deployed. Further, the cross-car beam may also form a portion of the instrument panel and support a variety of parts, fasteners and components. Accordingly, the cross-car beam must have high structural integrity and be generally rigid to support the frame of the vehicle and multiple instrument panel components.

In order to provide rigidity and structural integrity, traditional cross-car beams are typically manufactured from a metallic material. One particular metallic material is magnesium. The use of magnesium in cross-car beams provides the necessary rigidity and structural integrity while minimizing the overall weight of the beam. A lightweight cross-car beam reduces the overall weight of the vehicle and thus improves gas efficiency of the vehicle. However, metallic materials, and in particular magnesium, is costly. Further, tooling costs associated with the manufacture of magnesium cross-car beams is also expensive.

Further, environmental concerns are urging vehicle manufacturers to minimize the negative effects automobiles have on the environment. One suggestion is an improvement in gas efficiency. As discuss previously, a lightweight vehicle, and specifically a lightweight cross-beam, help to improve the gas efficiency of the vehicle. Additionally, the ability to recycle components of a vehicle is also desirable. Currently, recycling a metallic cross-car beam into another component for a vehicle is difficult and costly. It is desirable to have a cross-car beam made of a material that is easy recyclable into other components for the vehicle.

Cross-car beams are also commonly referred to as carriers for instrument panel assemblies. The cross-car beam is a base structure supporting instrument panel accessories such as glove boxes, radios and the like. Accordingly, the cross-car beams preferably include a variety of fasteners or attachment points to receive the miscellaneous components of the instruments panel. Further, the design of the cross-car beam is also variable depending upon the overall vehicle design. Therefore, it is desirable to manufacture a cross-car beam from a material that facilitates a flexible design and also integrates fasteners or attachment points to receive components of the instrument panels.

One possible material for a cross-car beam is a plastic material, such as a thermoplastic. However, the plastic material alone does not provide the necessary rigidity and structural integrity needed for a cross-car beam. Therefore, manufacturers have attempted to structurally reinforce the plastic materials, but such attempts have failed because of structural load requirements.

As such, a need exists for an improved cross-car beam that is cost effective to manufacture, lightweight, easily recyclable and able to integrate a plurality attachment points while still providing the necessary rigidity and structural integrity necessary for a vehicle cross-car beam.

### SUMMARY OF THE INVENTION

The inventors of the present invention have recognized these and other problems associated with cross-car beams. To this end, the inventors have developed a cross-car beam comprising a plastic material impregnated with long reinforcement fibers that provide increased strength and rigidity as compared to traditional cross-car beams.

### BRIEF DESCRIPTION OF THE DRAWINGS

The present invention will now be described, by way of example, with reference to the accompanying drawings, in which:

FIG. 1 illustrates an exemplary embodiment of a cross-car beam of the present invention comprised entirely of a plastic material having long reinforcement fibers; and

FIG. 2 illustrates a second exemplary embodiment of the cross-car beam of the present invention having a first metallic portion and a second plastic portion having long reinforcement fibers.

### DETAILED DESCRIPTION

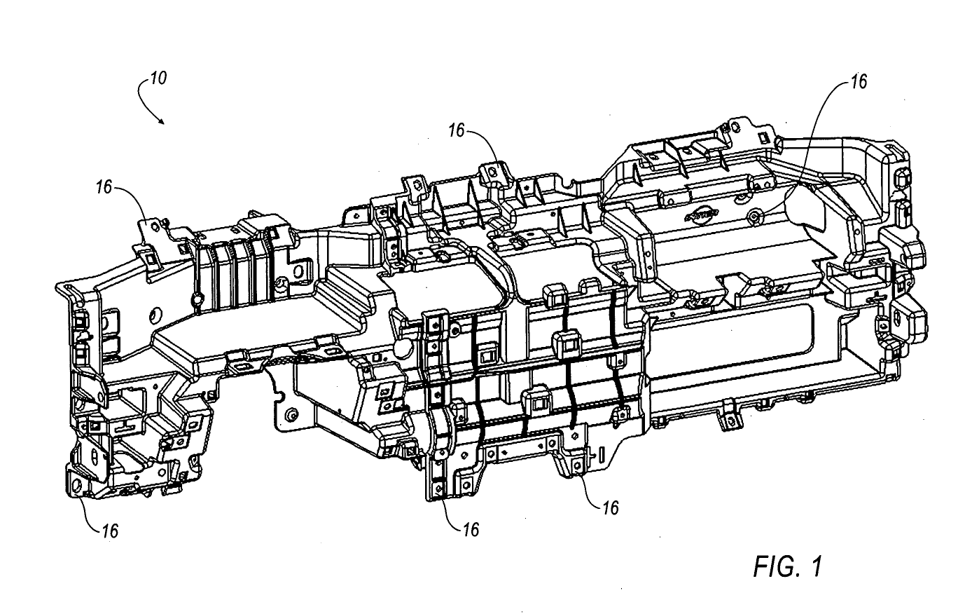

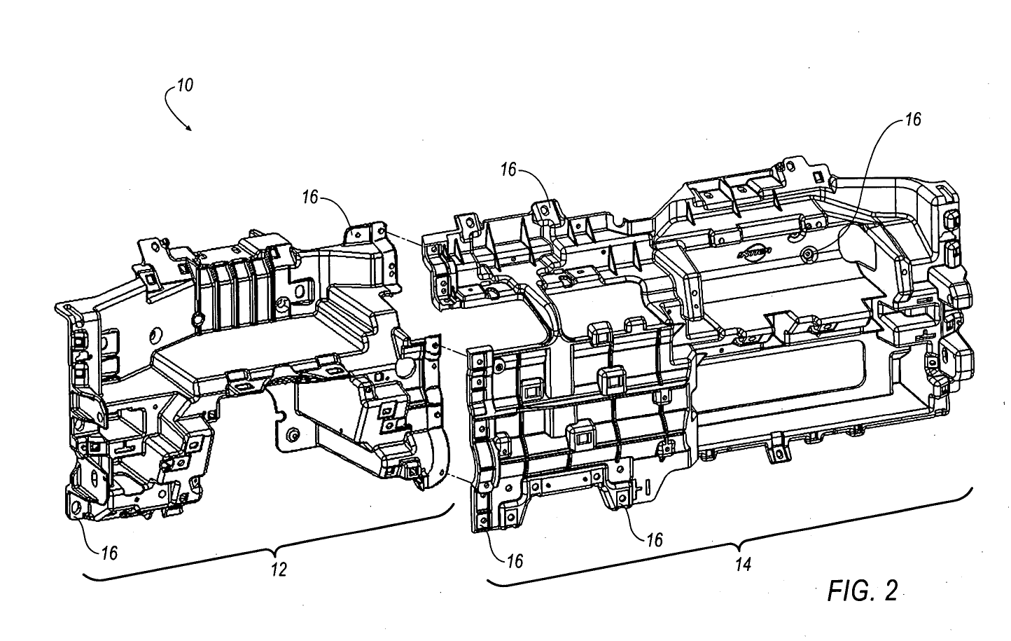

Referring to FIGS. 1 and 2, a cross-car beam is shown generally at 10 according to two embodiments of the invention. The first embodiment, shown in FIG. 1, is entirely comprised of a plastic material having long reinforcement fibers (not shown). Meanwhile, the second embodiment, shown in FIG. 2, includes a first portion 12 and a second portion 14. The first portion 12 is generally comprised of a metallic material, such as magnesium and the like. The second portion 14 is generally comprised of the plastic material having long reinforcement fibers. It is contemplated that the second embodiment includes about one-third of the cross-car beam 10 comprising the first portion 12 and about two-thirds of the cross-car beam comprising the second portion 14. Preferably, the first portion 12 extends from the driver's side of the vehicle inwardly and accommodates the steering column (not shown). Accordingly, the second portion extends from the passenger's side of the vehicle inwardly. The first and second portions 12, 14 are joined or connected to form the cross-car beam 10.

The long reinforcement fibers included in the plastic material are added to increase the structural integrity and rigidity of the cross-car beam 10. The long reinforcement fibers are generally reinforcement fibers having a length of at least three-quarters of an inch (19.05 mm). Preferably, the length of the long fibers is at least one inch (25.4 mm). Generally, longer reinforcement fibers add more rigidity and structural integrity to the cross-car beam 10 than traditional shorter fibers of having a typical length of only about 10 mm. Additionally, the present invention further contemplates that other strengthening materials, such as a strengthening mat, may be utilized in addition to, or in substitution for, the reinforcement fibers.

The plastic material is preferably a thermoplastic and olefin based material. As such, the olefin based material is easily reground and used for other applications in a vehicle, such as load floors, and the like. The plastic material facilitates manufacture of the cross-car beam 10 by traditional techniques, such as injection molding, compression molding, and the like. Further, the plastic material facilitates greater flexibility with the design of the cross-car beam 10 because material and tooling costs are generally less expensive than with traditional magnesium beams. Additionally, the plastic material permits local reinforcement of particular high stress areas of the cross-car beam 10 by inserting strengthening mats, a concentration of reinforcement fibers, bushing and the like in the particular high stress areas of the beam 10.

The long reinforcement fibers are preferably glass fibers. However, other types of reinforcement fibers, such as metal fibers, steel fibers, carbon fibers, natural fibers, wood fibers, graphite fibers, polyester fibers, and the like, are also contemplated by the present invention. Regardless of the type of reinforcement fiber, the blend ratio of plastic material to reinforcement fiber is preferably about 60% to about 40%. Thus, the composition of cross-car beam 10 includes about 60% of the plastic material and about 40% of the glass reinforcement fibers.

An additional feature of the cross-car beam 10 of the present invention further comprising a plurality of attachment points 16. The attachment points 16 include locators, bosses, or any other technique commonly used by one skilled in the art to attach mating components. It is contemplated that the cross-car beam 10 is attached to the A-pillars of the vehicle. It is further contemplated that various components of a traditional instrument panel, such as glove boxes, radios, steering columns, and the like, are also attached to the cross-car beam 10. Accordingly, the cross-car beam 10 of the present invention includes integrally formed attachment points 16 for receiving the components, fasteners, and the like.

Further, the cross-car beam 10 may also include a second material (not shown). The second material is preferably an in-mold-coat, film, flock, cloth, and the like, to create an “A-surface” as understood by one skilled in the art. Preferably, the second material is attached to one or more surfaces of the cross-car beam 10 that may be visible to the occupant of the vehicle to form a decorative surface.

The preferable process used to create the cross-car beam 10 of the present invention is a compression molding process as understood by one skilled in the art. The process of creating the billet of material used in the traditional compression molding process includes mixing the long reinforcement fibers with the plastic material. Attempts to mix long reinforcement fibers with the plastic material utilizing traditional mixing techniques often fractures and shortens the length of the fibers and thus results in a weaker cross-car beam. The mixing process combining long reinforcement fibers (i.e. at least three-quarters of an inch) of the present invention with the plastic material to produce the billet for forming the cross-car beam 10 is a proprietary process of Intier Automotive, Inc. The propriety process is generally referred to as “HyImpact Technology” and the composition of the plastic material with long reinforcement fibers is generally referred to as “Myplas 40.” More information on the proprietary process is available by contacting Intier Automotive, Inc., 39600 Lewis Drive, Novi, Mich., 48377, USA.

It should be understood that the aforementioned and other various alternatives to the embodiments of the invention described herein may be employed in practicing the invention. It is intended that the following claims define the scope of the invention and that the apparatus within the scope of these claims and their equivalents be covered thereby.

1. A cross-car beam comprising:
a plastic material impregnated with long reinforcement fibers; and
wherein said long reinforcement have a length of at least three-quarters of an inch.

2. The cross-car beam according to claim 1, wherein said length of said long reinforcement fibers is at least one inch.

3. The cross-car beam according to claim 1, wherein said plastic material is a thermoplastic.

4. The cross-car beam according to claim 1, wherein a blend ratio of said plastic material is about 60% plastic material to about 40% long reinforcement fibers.

5. The cross-car beam according to claim 1, wherein a portion of the cross-car beam is comprised of a metallic material.

6. The cross-car beam according to claim 5, wherein said metallic material is comprised of magnesium.

7. The cross-car beam according to claim 1, wherein said long reinforcement fibers are comprised of glass fibers.

8. The cross-car beam according to claim 1, wherein said long reinforcement fibers are selected from the group consisting of metal fibers, steel fibers, carbon fibers, natural fibers, wood fibers, graphite fibers, and polyester fibers.

9. The cross-car beam according to claim 1, further comprising a plurality of attachment points.

10. The cross-car beam according to claim 1, includes a surface generally visible to an occupant of a vehicle.

11. A cross-car beam comprising:
a first portion comprised of a metallic material;
a second portion connected to said first portion and comprised of a plastic material impregnated with long reinforcement fibers; and
wherein said long reinforcement fibers have a length of at least three-quarters of an inch.

12. The cross-car beam according to claim 11, wherein said long reinforcement fibers have a length of at least one inch.

13. The cross-car beam according to claim 11, wherein said plastic material is a thermoplastic.

14. The cross-car beam according to claim 11, wherein a blend ratio of said plastic material is about 60% plastic material to about 40% long reinforcement fibers.

15. The cross-car beam according to claim 11, wherein said metallic material is comprised of magnesium.

16. The cross-car beam according to claim 11, wherein said long reinforcement fibers are selected from the group consisting of metal fibers, steel fibers, carbon fibers, natural fibers, wood fibers, graphite fibers, and polyester fibers.

17. The cross-car beam according to claim 11, further comprising a plurality of attachment points.

18. The cross-car beam according to claim 11, includes a surface generally visible to an occupant of a vehicle.
